(19) United States
(12) Patent Application Publication
(10) Pub. No.: US 2010/0309676 A1
(43) Pub. Date: Dec. 9, 2010

(54) VEHICULAR LIGHTING DEVICE

(75) Inventor: Keng-Sheng LIN, Chang Hua (TW)

Correspondence Address: BROWDY AND NEIMARK, P.L.L.C.;624 NINTH STREET, NW, SUITE 300, WASHINGTON, DC, 20001-5303, US

(73) Assignee: MAXZONE AUTO PARTS CORP., Fontana, CA (US)

(21) Appl. No.: 12/792,843

(22) Filed: Jun. 3, 2010

(30) Foreign Application Priority Data
Jun. 3, 2009 (TW) 98209699

(51) Int. Cl. F21V 7/09; F21V 7/00

(52) U.S. Cl. 362/517; 362/519

(57) ABSTRACT

A vehicular lighting device is composed of at least one light-emitting element, a lens for guiding the refraction of the light of the light-emitting element along an optical axis, a shield having a cut-off portion formed at an edge thereof and located on the same horizon as the optical axis, and a reflector mounted above the light-emitting element. The reflector includes a first reflective surface is parabolic, and a second reflective surface inclining against the optical axis according to the radian of the first reflective surface. After the first and second reflective surfaces are used for guiding and focusing the light on the cut-off portion, the first and second reflective surfaces can project the light to the lens. Accordingly, the second reflective surface can guide some residual light to effectively enhance luminous flux and light utilization.

### BACKGROUND OF THE INVENTION

1. Field of the Invention

The present invention relates generally to a lighting device, and more particularly, to a vehicular lighting device.

2. Description of the Related Art

Referring to FIG. 1, a car headlamp 1 as an example is primarily composed of a mask 11 and a blub 12 received in the mask 11. The mask 11 includes a reflective surface 111 formed at an internal side thereof. The bulb 12 includes a first tungsten filament set 121, a second tungsten filament set 122, and a shade 123 covered below the second tungsten filament set 122.

When the first tungsten filament set 121 is selected for lighting, the light of the first tungsten filament set 121 emits on the reflective surface 111 and then is projected in the distance for high beam. When the second tungsten filament set 1212 is selected for lighting, the light of second tungsten filament set 122 partially shaded by the shade 123 and then projected in the distance for low beam.

The aforesaid car headlamp 1 as the same as the commercially available car headlamp is designed to change the projection area of the light in the manner of light shading for switchover between high beam and low beam. However, when a part of the light source is shaded for low beam, the luminous flux of the illumination is greatly reduced to lower the brightness of the car headlamp 1 for the low beam thus seriously affecting the driving safety.

### SUMMARY OF THE INVENTION

The primary objective of the present invention is to provide a vehicular lighting device, whose luminous flux and light utilization are enhanced.

The foregoing objective of the present invention is attained by the vehicular lighting device comprising at least one light-emitting element, a lens, a shield, and a reflector. The lens can guide the refraction of the light of the light-emitting element along an optical axis. The shield includes a cut-off portion formed at an edge thereof and located on the same horizon as the optical axis. The reflector is mounted above the light-emitting element and includes a first reflective surface and a second reflective surface. The first reflective surface is parabolic. The second reflective surface with the radian of the first reflective surface inclines against the optical axis. After the first and second reflective surfaces are used for guiding and focusing the light on the cut-off portion, the first and second reflective surfaces can reflect the light to the lens.

### BRIEF DESCRIPTION OF THE DRAWINGS

FIG. 1 is a side view of a conventional car headlamp.

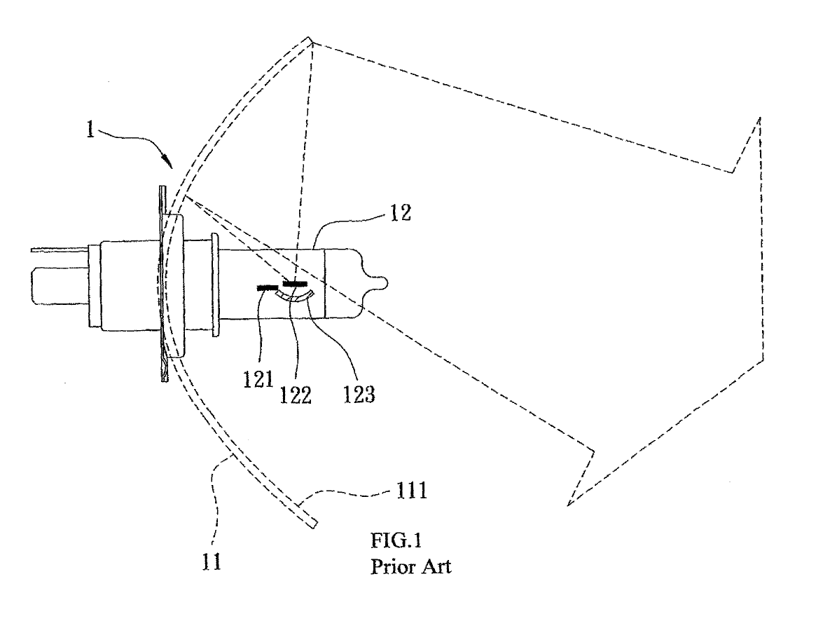

FIG. 2 is an exploded view of a preferred embodiment of the present invention.

FIG. 3 is a schematic side view of the preferred embodiment of the present invention.

FIG. 4 is a schematic top view of the preferred embodiment of the present invention.

### DETAILED DESCRIPTION OF PREFERRED EMBODIMENTS

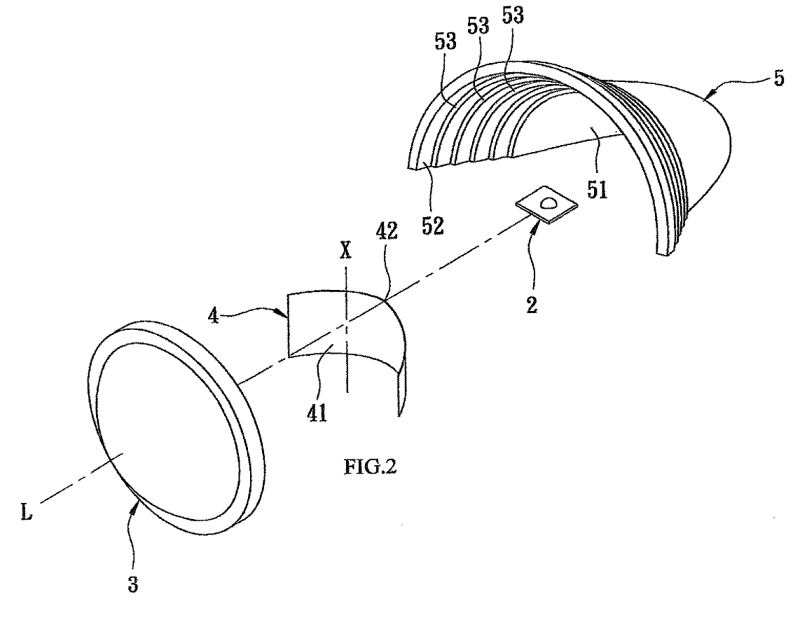

Referring to FIGS. 2-4, a vehicular lighting device constructed according to a preferred embodiment of the present invention is comprising a light-emitting element 2, a lens 3, a shield 4, and a reflector 5. The detailed descriptions and operations of these elements as well as their interrelationships are recited in the respective paragraphs as follows.

The light-emitting element 2 is a light emitting diode (LED) in this embodiment.

The lens 3 is a convex lens in this embodiment for refracting the light of the light-emitting element toward a direction parallel to an optical axis L.

The shield 4 is located below the optical axis and includes a curved body whose concave side faces toward the light-emitting element 2 and whose center is passed through by an imaginary axial line X perpendicular to the optical axis L; a reflective surface 41 formed at a side thereof and facing the lens 3; and a cut-off portion 42 formed at an upper edge of the shield 4 and located on the same horizon as the optical axis L.

The reflector 5 is mounted above the light-emitting element 2 and includes a first reflective surface 51 is parabolic, a second reflective surface 52 elongating from the first reflective surface 51 and sloping toward a direction away from the optical axis L, and a plurality of microstructures 53 formed on the second reflective surface 52. Each of the microstructures 53 can be a convexity, a concavity, or a combination of both. In this embodiment, the microstructures 53 can be stepped, semi-circular, or a combination of both.

When the vehicular lighting device is switched to low beam, the light of the light-emitting element 2 is emitted upward on the first reflective surface 51, the second reflective surface 53 and the microstructures 52, and then refracted to focus on the cut-off portion 42. In this way, the cut-off portion 42 of the shield 4 can generate a focus and control the light pattern and projected area of the light, and the light projected toward a lower part of the lens 3 for refracting along the direction parallel to the optical axis L.

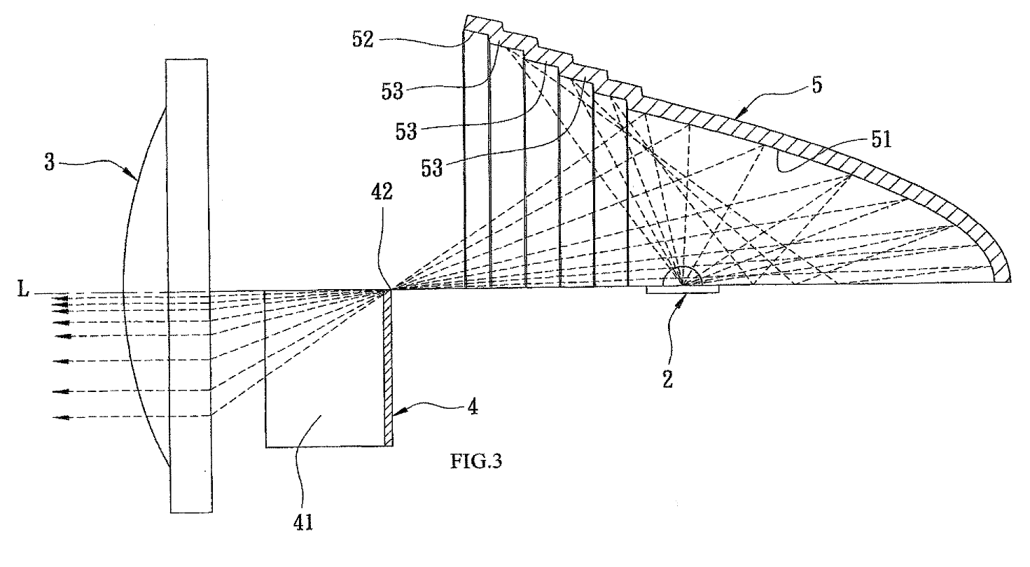

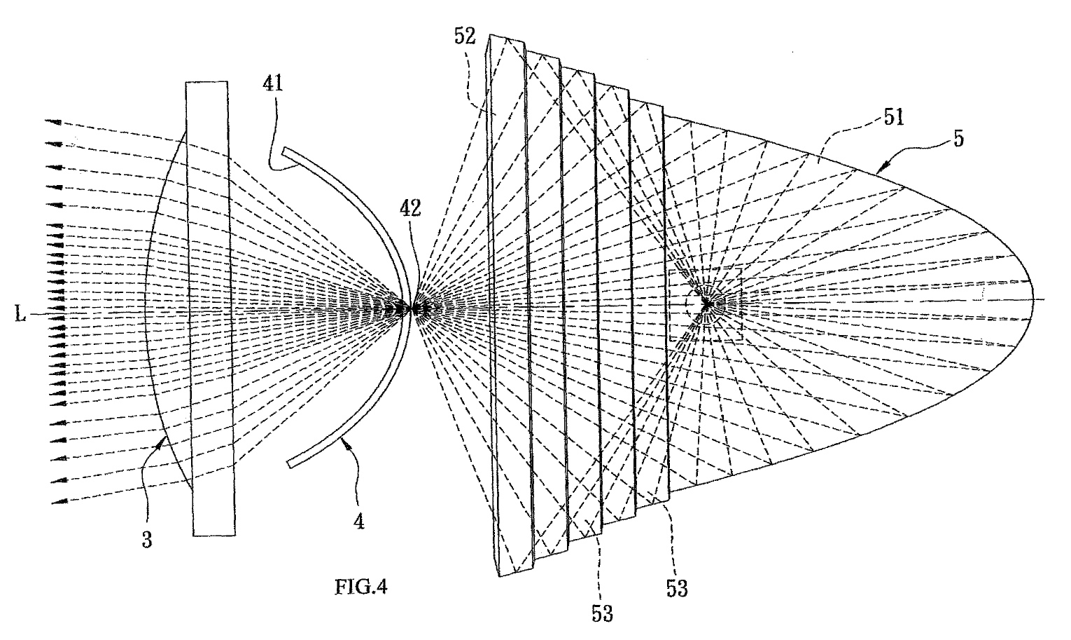

Because the aforesaid parabolic curve for the reflector 5 extends from a position far from the focus (the cut-off portion 42) to a position close to the focus, the closer it is to the focus (cut-off portion 42), the more refracted light deviates from the focus. Although the second reflective portion 52 is closer to the focus (cut-off portion 42), with the slope away from the optical axis L, the second reflective portion 52 can guide a residual light of light-emitting element 2 as showed in FIGS. 3-4. Then, the residual light focused on the cut-off portion 42 to enhance the light utilization and luminous flux for more brightness of the illumination.

It is to be noted that the depth, included angle, and density of arrangement of the microstructures 53 can change how much the light refraction is, thus enhancing the luminous flux of the light focusing on the cut-off portion 42. For this reason, the microstructures 53 can be arranged upon an on-demand basis for optimal brightness of the illumination. Besides, the shield 4 is provided with some radian to block the light via the reflective surface 41 from leakage toward two sides of the optical axis L, such that the luminous flux can also be enhanced.

In conclusion, the present invention includes the following advantages.

1. The specially designed first and second reflective surfaces 51 and 52 with the microstructures 53 can guide some residual light to effectively enhance the light utilization and the luminous flux of the light focusing on the cut-off portion 42.

2. The shield 4 can prevent the light from leakage to effectively enhance the brightness of illumination for practicality and safety.

Although the present invention has been described with respect to a specific preferred embodiment thereof, it is in no way limited to the specifics of the illustrated structures but changes and modifications may be made within the scope of the appended claims.

What is claimed is:

1. A vehicular light device comprising:
at least one light-emitting element;
a lens for guiding the light of the light-emitting element along a direction parallel to an optical axis;
a shield having a cut-off portion formed at an edge of the shield and located on the same horizon as the optical axis; and
a reflector mounted above the light-emitting element and having a first reflective surface and a second reflective surface, the first reflective surface is parabolic, the second reflective surface elongating from the first reflective surface and sloping toward a direction away from the optical axis, the first and second reflective surfaces being adapted for focusing the light on the cut-off portion and reflecting the light to the lens.

2. The vehicular light device as defined in claim 1, wherein the reflector further comprises a plurality of microstructures formed on the second reflective surface.

3. The vehicular light device as defined in claim 2, wherein the microstructures each can be a convexity, a concavity, or a combination of both.

4. The vehicular light device as defined in claim 1, wherein the shield is located below the optical axis.

5. The vehicular light device as defined in claim 1, wherein the shield comprises a curved body whose concave side faces toward the light-emitting element and whose center is passed through by an imaginary axial line perpendicular to the optical axis.

6. The vehicular light device as defined in claim 1, wherein the lens is a convex lens.
